(19) United States
(12) Patent Application Publication
(10) Pub. No.: US 2008/0282753 A1
(43) Pub. Date: Nov. 20, 2008

(54) Padlock

(76) Inventors: Rosemarie Hecht, Gera (DE); Michael Riesel, Weida (DE); Dietmar Plich, Gera (DE)

Correspondence Address: BODNER & O'ROURKE, LLP, 425 BROADHOLLOW ROAD, SUITE 108, MELVILLE, NY, 11747, US

(21) Appl. No.: 11/662,815

(22) PCT Filed: Sep. 16, 2005
(86) PCT No.: PCT/EP05/10009

§ 371 Date: Feb. 13, 2008

(30) Foreign Application Priority Data
Sep. 20, 2004 (DE) 10 2004 045 531.7
Jun. 10, 2005 (DE) 10 2005 026 930.3

(51) Int. Cl. E05B 67/08

(52) U.S. Cl. 70/35

(57) ABSTRACT

The invention relates to a padlock consisting of a lock casing body and a lock shackle, the ends of said shackle being received in recesses in the lock casing body. A first shackle end comprises a return gap for blocking the movement of the shackle in the locked state, and a second shackle end comprises a groove for defining the movement of the shackle in the opened state. Furthermore, an inwardly extending recess oriented parallel to the shackle ends and used to receive an entire standard locking cylinder, especially a standard half locking cylinder, is provided in the bottom region of the lock casing body, opposing the lock shackle. According to the invention, a displaceable and/or pivotable actuating element is provided in the displacement path of the lock bit of the standard locking cylinder. A first displacement part and a second displacement part are arranged inside a borehole used as a guide or a recess of the lock casing body, essentially perpendicularly to the longitudinal axis of the standard locking cylinder and adjacent to the same. The facing inner ends of the displacement parts are each provided with a bevel in such a way that, when the actuating element is displaced in relation to the lock bit, it hits the bevels, converting the lock bit pivoting movement into a longitudinal movement of the displacement parts. Furthermore, a blocking return gap is provided in the second shackle end of the lock shackle, opposing the return gap in the first shackle end. The first and second displacement parts respectively comprise a recess on the ends thereof opposing the bevels, said recesses corresponding to the dimensions of the respective shackle end. The displacement parts are elastically prestressed in the direction of the bevels, and when the lock bit is located at a distance from the actuating element, the actuating element releases the bevels such that the respective displacement parts can engage, in the region of the recesses thereof, in the respective blocking return gaps of the shackle ends.

The invention relates to a padlock consisting of a lock casing body and a lock shackle, the ends of said shackle being received in recesses in the lock casing body, wherein a first shackle end comprises a return gap for blocking shackle movement in the locked state and a second shackle end comprises a groove for limiting shackle movement in the opened state, with an inwardly-extending recess oriented parallel to the shackle ends furthermore being provided in the bottom region of the lock casing body opposite the lock shackle to fully receive a standard locking cylinder, in particular a standard half-locking cylinder, in accordance with the precharacterizing part of claim 1.

Known padlocks make use of specially-adapted profiled cylinders, whereby various different specially-made locking elements are necessary in order to transmit the rotational movement of the key. These circumstances yield the necessity of separate manufacturing as well as cost-intensive storage of the variety of parts needed.

There are furthermore essentially manufacturer-specific solutions such that a defective locking system of one manufacturer cannot be replaced by a locking system of another manufacturer, meaning that there is no compatibility, which represents a considerable disadvantage for the end consumer; i.e. the customer.

As is generally known, the dimensions of locking cylinders or half-locking cylinders for mortise locks or other similar locking systems correspond to the German DIN 18252 dindustrial standard. Among other things, this standard pertains to the external dimensions of such locking cylinders of, in principle, correspondingly standard manufacture. When owners change, e.g. in an apartment, the locking cylinder can thus be easily replaced with a new locking cylinder without it being necessary to replace and/or dismantle the entire lock.

With this described background art in mind, a further-developed padlock is proposed consisting of a lock casing body and a lock shackle, the ends of said shackle being received in recesses in the lock casing body, and wherein a first shackle end comprises a return gap or a clearance for blocking movement of the shackle in the locked state, whereby an inwardly-extending recess oriented parallel to the shackle ends is provided in the bottom region of the lock casing body opposite the lock shackle to fully receive a standard half-locking cylinder. In this proposed further-developed padlock, the standard half-locking cylinder as employed engages in the return gap or the clearance in the first shackle end in the locked position, whereby the width of the return gap essentially corresponds to the width of the lock bit. A defined recess for receiving the standard half-locking cylinder enables this padlock to make use of such a conventional standard component in the lock casing body without needing additional locking elements as well as having it realize a secure locking. The lock bit of the standard half-locking cylinder as employed accordingly serves as the locking element and, unlike the case with previously-known padlocks, no additional locking elements are necessary.

With known locks, the lock shackle is tailored to such a degree to the associated drillhole in the lock casing body that when the lock shackle is pushed in, the clearance is situated at exactly the same height as the lock bit. When locking a standard half-locking cylinder, the lock bit pivots into the clearance of the shackle and remains in this position after the key has been removed so as to create a secure locking of the shackle.

Then, when the standard half-locking cylinder is unlocked, the lock bit is pivoted out of the clearance of the shackle and the shackle thereby released and then pressed out of the lock casing body by means of a pressure spring, in particular a helical compression spring, situated in the housing.

Although the above-described padlock with standard locking cylinder already exhibits considerable advantages in terms of reducing the number of parts and the costs, the fact that the locking cylinder needs to be actuated by movement of a key in order to lock is still regarded as being a disadvantage.

Taking the described disadvantages of the prior art into account, the task which the present invention addresses is that of providing a further-developed padlock consisting of a lock casing body as well as a lock shackle, the ends of said shackle being received in recesses in the lock casing body, wherein a first shackle end comprises a return gap for blocking shackle movement in the locked state and a second shackle end comprises a groove for limiting shackle movement in the opened state, with an inwardly-extending recess oriented parallel to the shackle ends furthermore being provided in the bottom region of the lock casing body opposite the lock shackle to fully receive a standard locking cylinder, in particular a standard half-locking cylinder, whereby this padlock to be provided evinces its desired function without requiring the locked position in order to withdraw the key and locks from both sides.

This task of the invention is solved by a padlock according to the feature combination of claim 1, whereby the subclaims encompass at least functional embodiments and further developments.

The invention sets out from a padlock consisting of a lock casing body as well as a lock shackle, the ends of said shackle being received in recesses in the lock casing body, wherein an inwardly-extending recess oriented parallel to the shackle ends is provided in the bottom region of the lock casing body opposite the lock shackle to fully receive a standard locking cylinder.

According to the invention, a displaceable and/or pivotable actuating element is disposed in the displacement path of the standard locking cylinder's lock bit.

A first and a second displacement part are arranged within a drillhole or a recess of the lock casing body serving as a guide adjacent and essentially perpendicular to the longitudinal axis of the standard locking cylinder. The inner facing ends of the displacement parts are chamfered such that when the actuating element is induced to move by the lock bit, it strikes the chamfers, whereby the pivoting motion of the lock bit is consequently converted into a longitudinal displacing movement of the displacement parts.

A blocking return gap is furthermore provided in the second shackle end of the lock shackle opposite the return gap in the lock shackle's first shackle end.

The respective first and second displacement part each exhibit a recess on their ends opposite the chamfers which is tailored to the dimensions of the respective shackle end.

The displacement parts are spring-tensioned toward the chamfers, whereby when the lock bit is in a position distanced from the actuating element, same then frees the chamfers such that the respective displacement parts can engage in the respective blocking return gaps of the shackle ends in the region of their recesses.

The actuating element can exhibit the form of a ball, a disk or a cylinder.

The inventive chamfers of the displacement parts are of V-configuration, whereby the open side of the V-shape is oriented to the actuating element.

In a first embodiment, the respective displacement parts are supported in the lock casing along their longitudinal axis by a pressure spring and are tensioned by said pressure spring.

In a second embodiment, securing means are respectively provided on the first and second displacement part to receive a respective end of a tension spring or a pair of tension springs which are unimpeded by the actuating element.

The recess for the second shackle end is a drillhole, its base region accommodating a helical compression spring.

A drillhole for a fastening bolt or a fastening pin of the standard half-locking cylinder is furthermore disposed in the lock casing body.

When the standard half-locking cylinder is dislodged, a shackle retaining pin can be removed in order to realize the complete dismantling and removal of the lock shackle and the above-cited helical compression spring, whereby lock shackles of different dimensions, in particular length, can thus be used.

The following will make reference to an embodiment as well as figures in describing the invention in greater detail. Shown are:

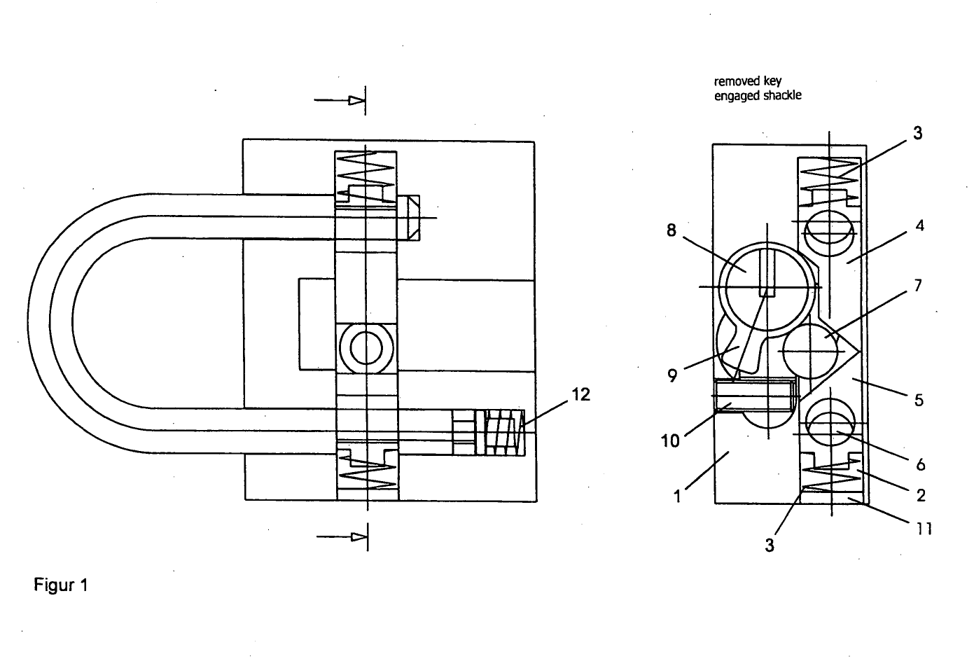

FIG. 1 a representation of a padlock designed for standard half-locking cylinders, locking from both sides, without requiring the locked position in order to withdraw the key, equipped with two pressure springs in the state of removed key and engaged shackle;

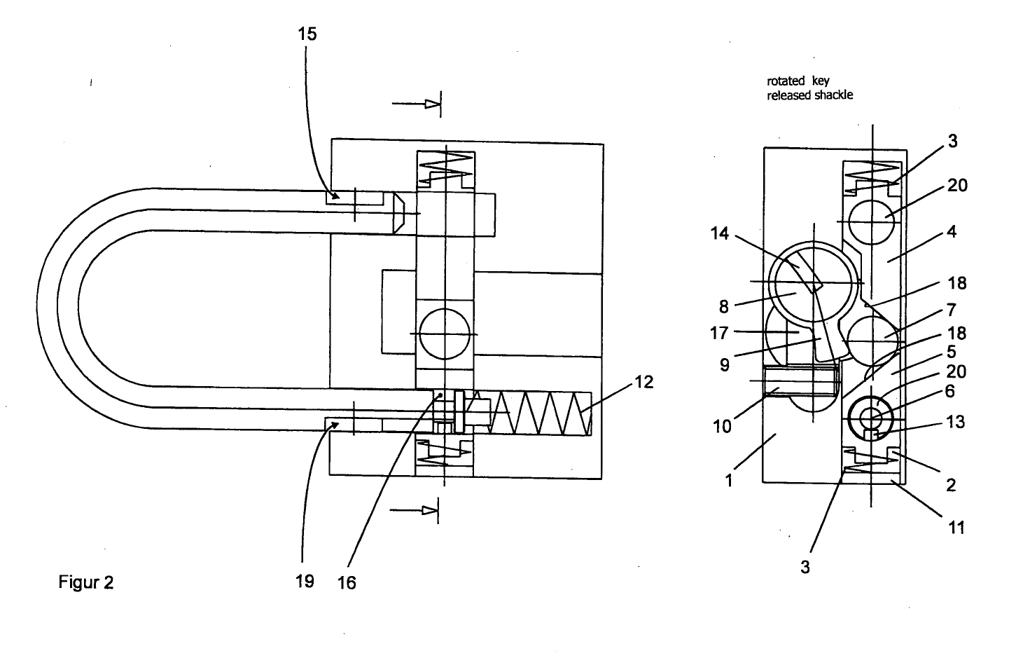

FIG. 2 a representation similar to that of FIG. 1 but with rotated key and released shackle;

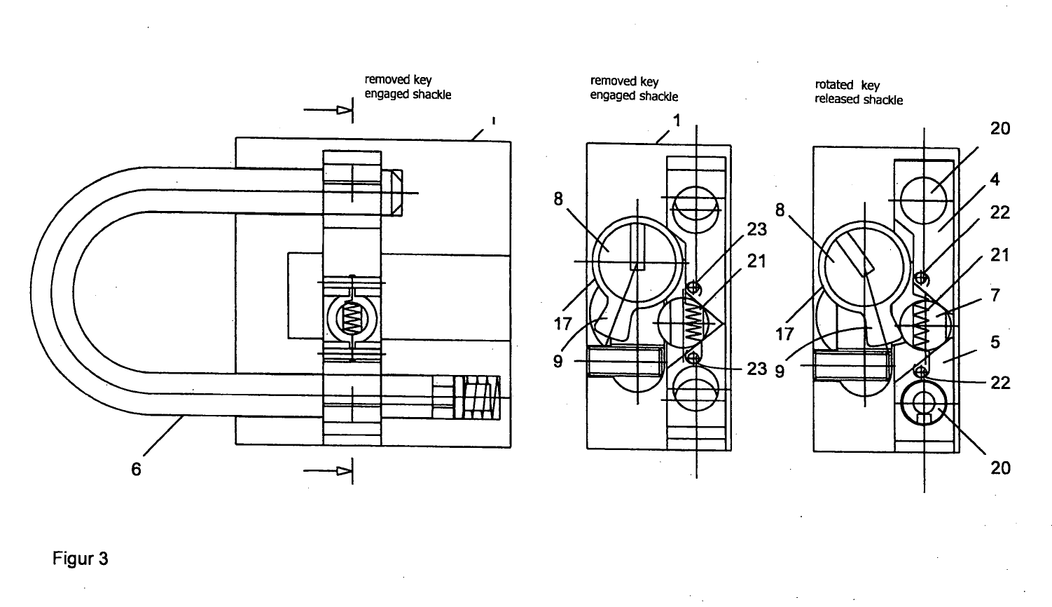

FIG. 3 a schematic diagram of a padlock designed for standard half cylinders, likewise locking from both sides, without requiring the locked position in order to withdraw the key, but with a tension spring to pre-load the displacement parts;

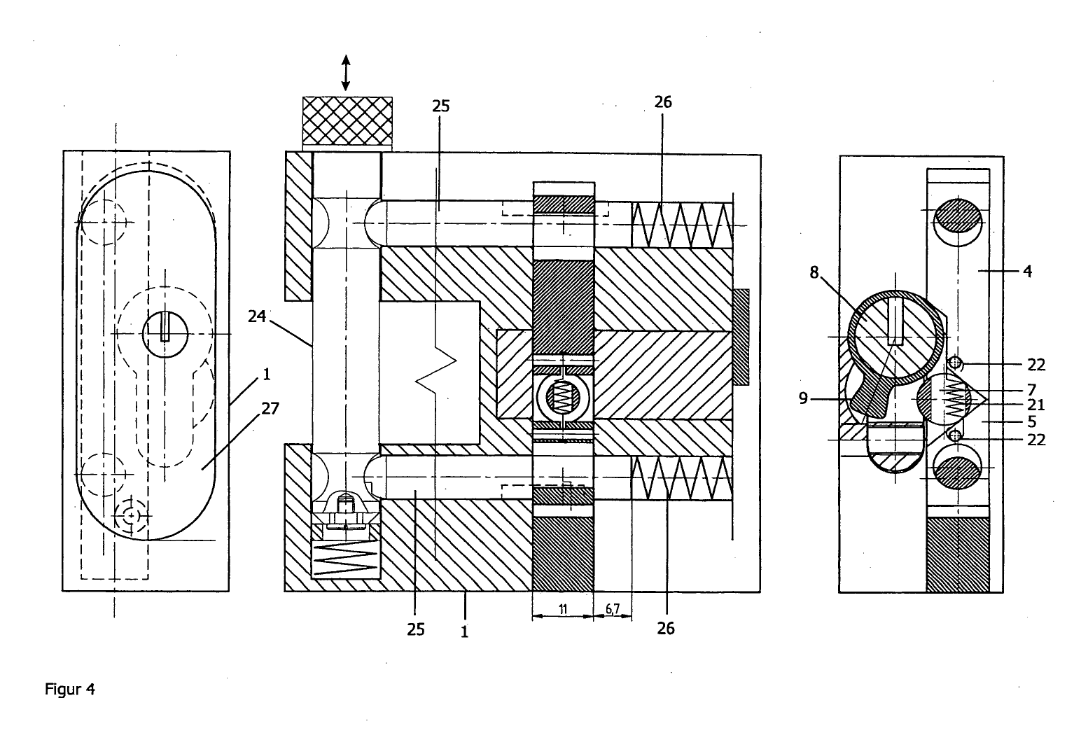

FIG. 4 a representation of a first embodiment with a cross-shackle, and

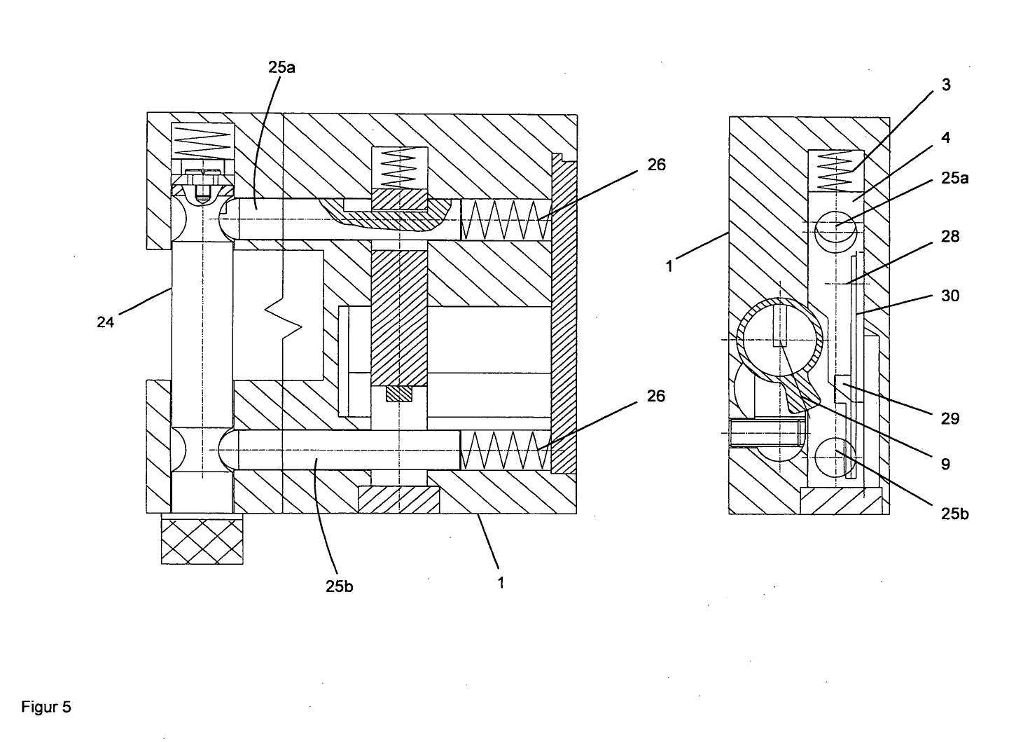

FIG. 5 a representation of a second embodiment with a cross-shackle.

The padlock according to the embodiments consists of a lock casing body or housing 1 which has recesses to receive the ends of a lock shackle 6.

A first shackle end (see FIG. 2) has a return gap 15 to block shackle movement in the locked state. A second shackle end has a groove 16 to limit the movement of the shackle in the opened state.

An inwardly-extending recess oriented parallel to the shackle ends is provided in the bottom region of the lock casing body 1 opposite lock shackle 6 to fully receive a standard locking cylinder 17.

An actuating element 7, e.g. in the form of a ball, is displaceably supported in the direction of displacement of lock bit 9.

A first displacement part 4 and a second displacement part 5 are arranged within a drillhole 2 or other such similar recess of lock casing body 1 serving as a guide adjacent and essentially perpendicular to the longitudinal axis of the standard locking cylinder 17.

The inner facing ends of displacement parts 4, 5 exhibit a chamfer 18 such that when the actuating element 7 is induced to move by the lock bit, it strikes said chamfers 18, whereby the pivoting motion of the lock bit is consequently con-verted into a longitudinal displacing movement of displacement parts 4, 5.

A blocking return gap 19 is provided in the second shackle end of lock shackle 6 opposite return gap 15.

The first and the second displacement part 4, 5 in each case exhibit a recess 20 on their ends opposite chamfers 18 which is tailored to the dimensions of the respective shackle ends of lock shackle 6.

Displacement parts 4, 5 are spring-tensioned in the direction of chamfers 18, whereby pursuant the embodiment according to FIGS. 1 and 2, a pressure spring 3 braced against the interior of the lock casing body 1, respectively a locking part 11, is provided for each respective part.

When the lock bit 9 is in a position distanced from actuating element 7, actuating element 7 then frees the chamfers 18 so that the respective displacement parts 4, 5 engage in the respective blocking return gap 15 or 19 of the shackle ends of lock shackle 6 in the area of its recesses 20 upon same being in the depressed position.

According to FIG. 2, when key 14 is inserted and cylinder core 8 turned, lock bit 9 is likewise entrained to displace in the direction of actuating element 7.

Actuating element 7 then exerts force on the chamfers 18 such that displacement parts 4 and 5 move upward and downward in the illustrated representation, and do so by overcoming the forces of the respective pressure spring 3. As a consequence, the shackle is released, moving outward in the left-hand representation of FIG. 2 by the force action of bow spring 12.

Standard locking cylinder 17 is releasably mounted in the housing by means of a screw fitting 10.

The functioning of the padlock, locking from both sides, without requiring the locked position in order to withdraw the key, pursuant the embodiment according to FIG. 3 is analogous to that as described using the representation according to FIGS. 1 and 2, although differing in that the spring tensioning is realized with one spring, namely a helical spring 21, the spring ends 22 of which hook into pin-shaped securing means 23.

The two chamfers 18 of displacement parts 4, 5 can preferably have the shape of a V, whereby, as can be seen in the figures, the open end of the V-shape is oriented toward actuating element 7.

A shackle pin 13 engages in the groove 16 of the second shackle end of lock shackle 6 so that lock shackle 6 cannot be extracted or removed from lock casing body 1 without further measures being necessary.

The embodiment according to FIG. 4 shows a shackle lock with a so-called cross-shackle. In this embodiment, the lock casing body is of substantially square configuration, whereby a displaceable cross-shackle 24 is fit in the recesses provided in the upper part.

Two displaceable pins 25 arrest the cross-shackle in the locked state.

The ends of the pins oriented toward the cross-shackle 24 have an inclination or a rounding so that when cross-shackle 24 moves in the direction indicated by the double arrow, same can either be pushed into or pulled out of the respective recess of lock casing body 1. When the cross-shackle 24 is being pulled out or inserted, a displacement of the pins 25 is effected in lock casing body 1 associated with the inclined surface or ball-shaped head surfaces of pins 25 in cooperation with a complementary groove thereto in cross-shackle 24. Pins 25 remain tensioned in all other respects as far as springs 26. In terms of their function, the first and second displacement parts 4, 5 are realized analogously to the embodiments according to FIGS. 1 to 3, whereby the two displacement parts 4, 5 either release or arrest the pins 25 depending on the position of actuating element 7 relative the position of the lock bit 9.

Another conceivable realization of a so-called retraction protector 27 as inserted into the bottom of lock casing body 1 is shown on the left-hand side of the illustration according to FIG. 4.

In the further embodiment of a shackle lock having a cross-shackle according to FIG. 5, the lock casing body is likewise exemplified by a square configuration, whereby a displaceable cross-shackle 24 is situated in the recesses provided at the upper part. Two displaceable pins 25a and 25b arrest said cross-shackle 24 in the locked state. The ends of pins 25a and 25b aligned to cross-shackle 24 are rounded off so that when cross-shackle 24 moves, they can either be pushed into or pulled out of the recess of lock casing body 1. The functioning of this second embodiment according to FIG. 5 corresponds in principle to that as described with respect to FIG. 4 with the exception of the modifications to be described below.

The second embodiment with cross-shackle provides added security against the lock being broken open. This added security yields from the effect of the pressure spring 3 shown in the figure in conjunction with the spring plate 30 which is fixed to the first displacement part 4 by means of a screw fitting 28.

When the key is turned, lock bit 9 is likewise entrained and turned. Lock bit 9 thereby strikes the first displacement part 4 and moves it outward against the force of pressure spring 3.

In this way, the first pin 25a is released. At the same time, lock bit 9 presses against the aforementioned spacer 29 which is mounted to spring plate 30. The spring plate 30 affixed to the first displacement part 4 is then withdrawn from the second pin 25b and thus likewise releases same. The advantage to the embodiment according to FIG. 5 over that of FIG. 4 is thus in the springs perpendicular action to one another, whereby the movement of the lock bit is transmitted directly to the displacement part.

All told, the padlock as realized, setting out from utilizing a standard half-locking cylinder, locking from both sides and also without requiring the locked position in order to withdraw the key, accomplishes a reduction in the number of parts and thus the manufacturing requirements when tooling such locks and occasions a high utilitarian value also in terms of increased security requirements.

### LIST OF REFERENCE NUMERALS

1 lock casing body
2 drillhole in lock casing body
3 pressure spring
4 first displacement part
5 second displacement part
6 lock shackle
7 actuating element
8 cylinder core
9 lock bit
10 screw fitting
11 locking part
12 bow spring
13 shackle pin
14 key
15 return gap
16 groove
17 standard locking cylinder
18 chamfer
19 blocking return gap
20 recess
21 helical spring
22 spring ends of helical spring
23 pin-shaped securing means for the ends of the helical spring
24 cross-shackle
25 pins
26 spring
27 retraction protector

1. A padlock consisting of a lock casing body and a lock shackle, the ends of said shackle being received in recesses in the lock casing body, wherein a first shackle end comprises a return gap for blocking shackle movement in the locked state and a second shackle end comprises a groove for limiting shackle movement in the opened state, with an inwardly-extending recess oriented parallel to the shackle ends furthermore being provided in the bottom region of the lock casing body opposite the lock shackle to fully receive a standard locking cylinder, in particular a standard half-locking cylinder,
characterized in that
a displaceable and/or pivotable actuating element is disposed in the displacement path of the lock bit of the standard locking cylinder, a first and a second displacement part are arranged within a drillhole or a recess of the lock casing body serving as a guide adjacent and essentially perpendicular to the longitudinal axis of the standard locking cylinder,
the inner facing ends of the displacement parts are chamfered such that when the actuating element is induced to move by the lock bit, it strikes the chamfers, whereby the pivoting motion of the lock bit is consequently converted into a longitudinal displacing movement of the displacement parts,
a blocking return gap is furthermore provided in the second shackle end of the lock shackle opposite the return gap in the first shackle end,
the respective first and second displacement part each exhibit a recess on their ends opposite the chamfers which is tailored to the dimensions of the respective shackle end and the displacement parts are spring-tensioned toward the ends of the chamfers, whereby when the lock bit is in a position distanced from the actuating element, same then frees the chamfers such that the respective displacement parts can engage in the respective blocking return gaps of the shackle ends in the region of their recesses.

2. The padlock according to claim 1,
characterized in that
the actuating element exhibits the form of a ball, a disk or a cylinder.

3. The padlock according to claim 1,
characterized in that
the chamfers of the displacement parts are of V-configuration, whereby the open side of the V-shape is oriented to the actuating element.

4. The padlock according to claim 1,
characterized in that
the respective displacement parts are each supported and tensioned in the lock casing body along their longitudinal axis by means of a pressure spring.

5. The padlock according to claim 1,
characterized in that
securing means are respectively provided on the first and second displacement part to receive a respective end of one or more tension springs.

6. The padlock according to claim 1,
characterized in that
the recess for the second shackle end is a drillhole, its base region accommodating a helical compression spring.

7. The padlock according to claim 1,
characterized in that
a drillhole for a fastening bolt of the standard half-locking cylinder is disposed in the lock casing body.

8. The padlock according to claim 1,
characterized in that
the lock shackle consists of a plurality of components, namely two pins (25) movable within lock casing body (1) as well as a cross-shackle (24) likewise insertable in lock casing body (1).

9. The padlock according to claim 1,
characterized in that
a plate-like retraction protection (27) is arranged at the bottom of the lock casing body.

10. The padlock according to claim 2,
characterized in that
the chamfers of the displacement parts are of V-configuration, whereby the open side of the V-shape is oriented to the actuating element.

11. The padlock according to claim 2,
characterized in that
the respective displacement parts are each supported and tensioned in the lock casing body along their longitudinal axis by means of a pressure spring.

12. The padlock according to claim 3,
characterized in that
the respective displacement parts are each supported and tensioned in the lock casing body along their longitudinal axis by means of a pressure spring.

13. The padlock according to claim 2,
characterized in that
securing means are respectively provided on the first and second displacement part to receive a respective end of one or more tension springs.

14. The padlock according to claim 3,
characterized in that
securing means are respectively provided on the first and second displacement part to receive a respective end of one or more tension springs.

15. The padlock according to claim 2,
characterized in that
the recess for the second shackle end is a drillhole, its base region accommodating a helical compression spring.

16. The padlock according to claim 3,
characterized in that
the recess for the second shackle end is a drillhole, its base region accommodating a helical compression spring.

17. The padlock according to claim 4,
characterized in that
the recess for the second shackle end is a drillhole, its base region accommodating a helical compression spring.

18. The padlock according to claim 5,
characterized in that
the recess for the second shackle end is a drillhole, its base region accommodating a helical compression spring.

19. The padlock according to claim 2,
characterized in that
a drillhole for a fastening bolt of the standard half-locking cylinder is disposed in the lock casing body.

20. The padlock according to claim 3,
characterized in that
a drillhole for a fastening bolt of the standard half-locking cylinder is disposed in the lock casing body.
